(19) United States
(12) Patent Application Publication
(10) Pub. No.: US 2006/0021857 A1
(43) Pub. Date: Feb. 2, 2006

(54) Conveyer belt-adjusting device for a conveyer unit

(76) Inventor: Juei-Seng Liao, Ta-Li City (TW)

Correspondence Address: OSTROLENK FABER GERB & SOFFEN, 1180 AVENUE OF THE AMERICAS, NEW YORK, NY, 100368403, US

(21) Appl. No.: 10/996,527

(22) Filed: Nov. 24, 2004

(30) Foreign Application Priority Data
Aug. 2, 2004 (TW) 093212227

(51) Int. Cl. B65G 39/16

(52) U.S. Cl. 198/810.03; 198/807

(57) ABSTRACT

A conveyer belt-adjusting device for a conveyer unit includes a platform for supporting two rollers at two opposite sides thereof. An endless conveyer belt is disposed around the rollers. A pushing rod extends along a transverse direction of the conveyer belt, and is disposed between the platform and a bottom belt portion of the conveyer belt, and is also between the rollers. The pushing rod presses against an intermediate portion of the bottom belt portion such that the intermediate portion of the bottom belt portion is disposed below two ends of the bottom belt portion. Two adjustable supporting units support respectively two opposite ends of the pushing rod on the platform, and are located respectively at two opposite sides of the conveyer belt. Relative vertical positions of the ends of the pushing rod can be changed by adjusting the supporting units.

### CROSS-REFERENCE TO RELATED APPLICATION

This application claims priority of Taiwanese Application No. 093212227, filed on Aug. 2, 2004.

### BACKGROUND OF THE INVENTION

1. Field of the Invention

This invention relates to a conveyer belt-adjusting device, and more particularly to a conveyer belt-adjusting device for a conveyer unit, the conveyer unit including two rollers and an endless conveyer belt disposed around the rollers.

2. Description of the Related Art

Referring to FIG. 1, a conventional polishing machine 1 is shown to include a worktable 11, a platform 12 disposed fixedly on the worktable 11, a polishing cloth unit 13 disposed rotatably on the platform 12, and an endless conveyer belt 14 disposed around the platform 12. Two rollers (not shown) are disposed on the platform 12 so as to allow for circulation of the conveyer belt 14 around the rollers (not shown) . A wooden workpiece 2 can be placed on a top belt portion of the conveyer belt 14 so as to move under the polishing cloth unit 13. This will allow the wooden workpiece 2 to be rubbed by the polishing cloth unit 13. After the conveyer belt 14 is placed around the platform 12, ends of the conveyer belt 14 are interconnected fixedly. However, a serious problem may occur when using the conventional polishing machine. Namely, referring to FIG. 2, a portion 141 of the conveyer belt 14 is apt to move relative to an end of the platform 12 along a transverse direction (A) of the conveyer belt 14 during use, thereby resulting in unsmooth movement of the wooden workpiece 2 (see FIG. 1).

### SUMMARY OF THE INVENTION

The object of this invention is to provide a conveyer belt-adjusting device for a conveyer unit, which can be adjusted to prevent transverse movement of a conveyer belt relative to a platform.

A conveyer belt-adjusting device for a conveyer unit includes a platform for supporting two rollers at two opposite sides thereof. An endless conveyer belt is disposed around the rollers. A pushing rod extends along a transverse direction of the conveyer belt, and is disposed between the platform and a bottom belt portion of the conveyer belt, and is also between the rollers. The pushing rod presses against an intermediate portion of the bottom belt portion such that the intermediate portion of the bottom belt portion is disposed below two ends of the bottom belt portion. Two adjustable supporting units support respectively two opposite ends of the pushing rod on the platform, and are located respectively at two opposite sides of the conveyer belt. Relative vertical positions of the ends of the pushing rod can be changed by adjusting the supporting units.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a conventional polishing machine;

FIG. 2 is a schematic fragmentary top view of the conventional polishing machine;

FIG. 3 is a side view of the preferred embodiment of a conveyer belt-adjusting device for a conveyer unit according to this invention;

FIG. 4 is a sectional view of the preferred embodiment, illustrating how a pushing rod is disposed on a platform; and

FIGS. 5 and 6 are sectional views of the preferred embodiment, illustrating how the inclination angle of the pushing rod is adjusted to prevent transverse movement of any portion of a conveyer belt on the platform.

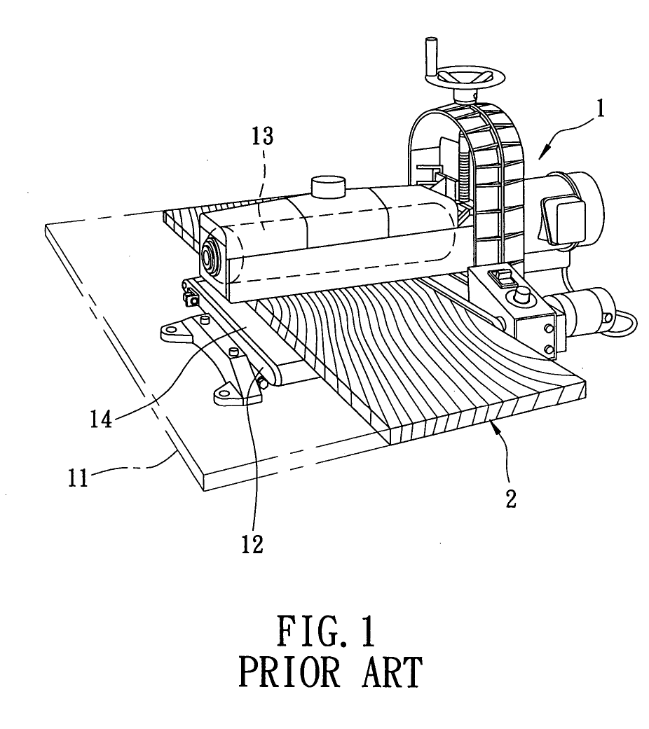

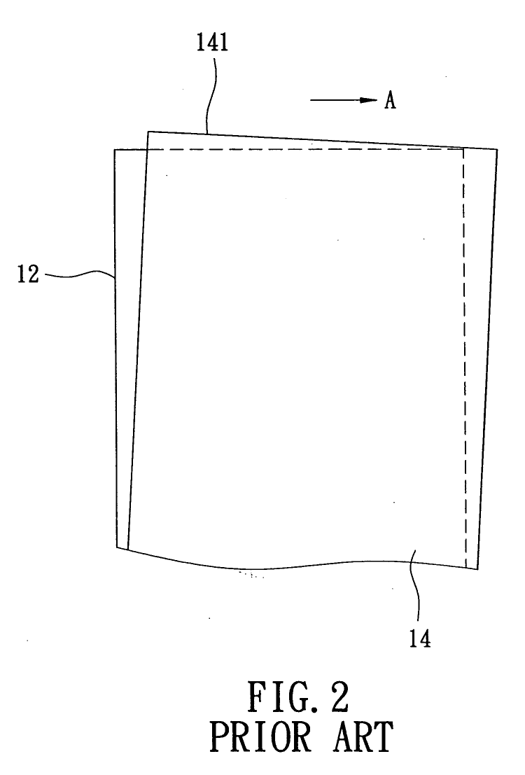

### DETAILED DESCRIPTION OF THE PREFERRED EMBODIMENT

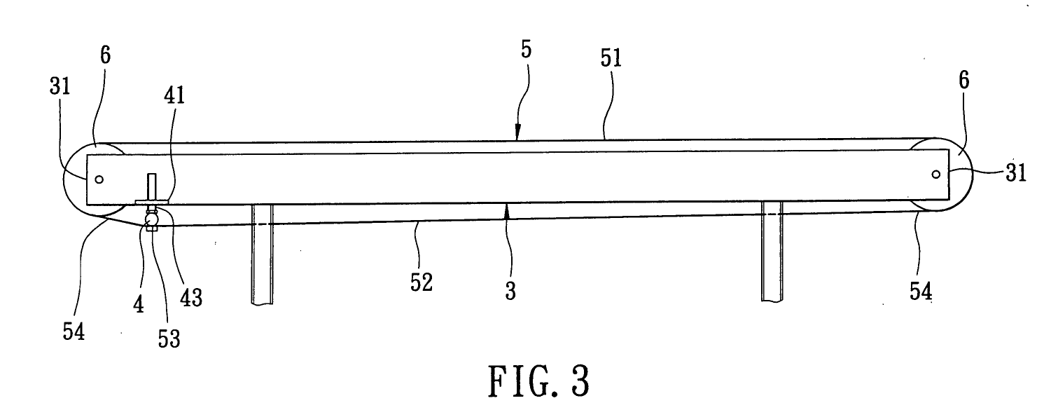

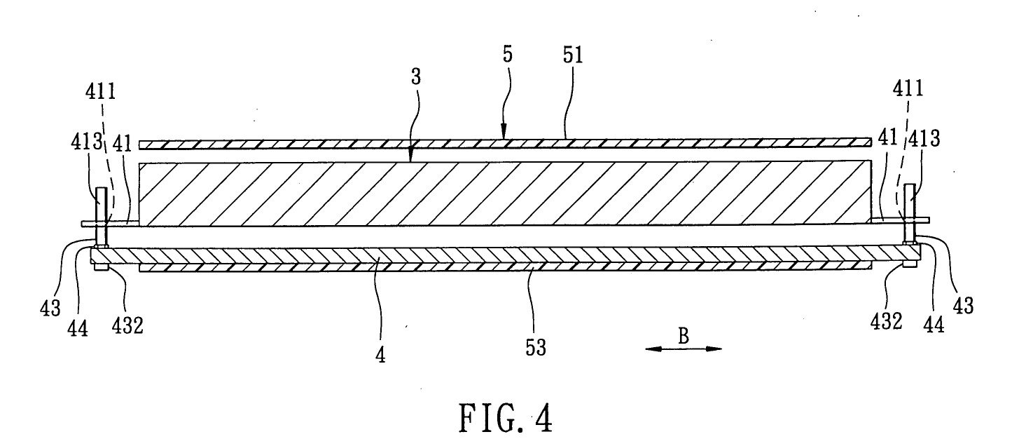

Referring to FIGS. 3, 4, and 5, the preferred embodiment of a conveyer belt-adjusting device for a conveyer unit according to this invention is shown to include a platform 3, a pushing rod 4, and two adjustable supporting units for supporting respectively two opposite ends of the pushing rod 4. The conveyer unit includes an endless conveyer belt 5 and two rollers 6. When stationary, the conveyer belt 5 has a horizontal top belt portion 51 extending between upper ends of the rollers 6, and a bottom belt portion 52 extending between lower ends of the rollers 6. The rollers 6 are disposed rotatably on two opposite sides 31 of the platform 3.

The pushing rod 4 extends along a transverse direction (B) of the conveyer belt 5, and is disposed between the platform 3 and the bottom belt portion 52 of the conveyer belt 5, and also between the rollers 6. The pushing rod 4 presses against an intermediate portion 53 of the bottom belt portion 52 of the conveyer belt 5 positioned adjacent to the left roller 6 such that the intermediate portion 53 of the bottom belt portion 52 is disposed below two ends 54 of the bottom belt portion 52.

The supporting units are located respectively at two opposite sides of the conveyer belt 5. Each of the supporting units includes a horizontal lug 41, a bolt 43, and a nut 44. Each of the lugs 41 is connected fixedly to the platform 3, and has a threaded hole 411 formed therethrough. Each of the bolts 43 has a threaded portion 431 engaging the threaded hole 411 in the corresponding lug 41, and a head 432 located under the corresponding lug 41 and abutting against a bottom surface of the pushing rod 4. Each of the nuts 44 engages the threaded portion 431 of the corresponding bolt 43 such that each of the ends of the pushing rod 4 is clamped between the corresponding nut 44 and the head 432 of the corresponding bolt 43. Using this configuration of the supporting units, the vertical position of each of the ends of the pushing rod 4 can be adjusted.

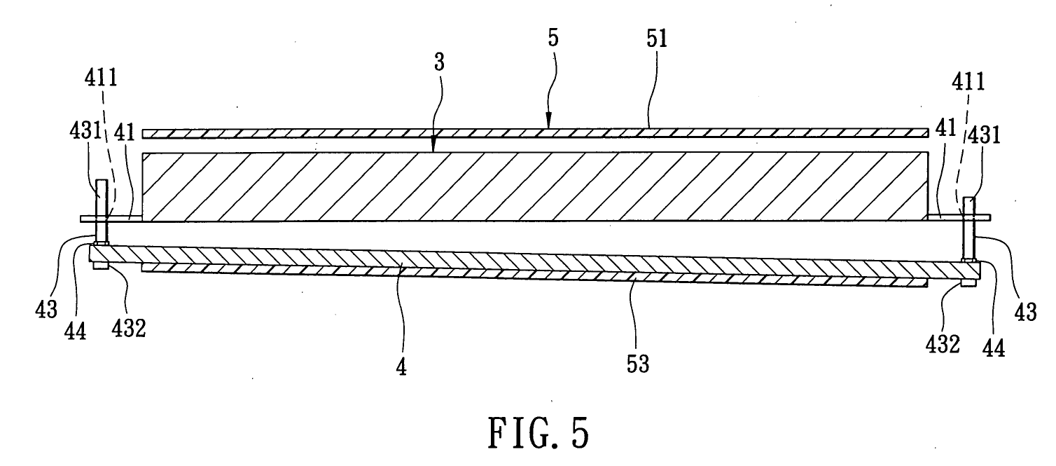

When it is found that the intermediate portion 53 tends to incline leftwardly and downwardly, the pushing rod 4 can be adjusted to a rightwardly and downwardly position shown in FIG. 5 so as to prevent transverse movement of the top belt portion 51 relative to the platform 3.

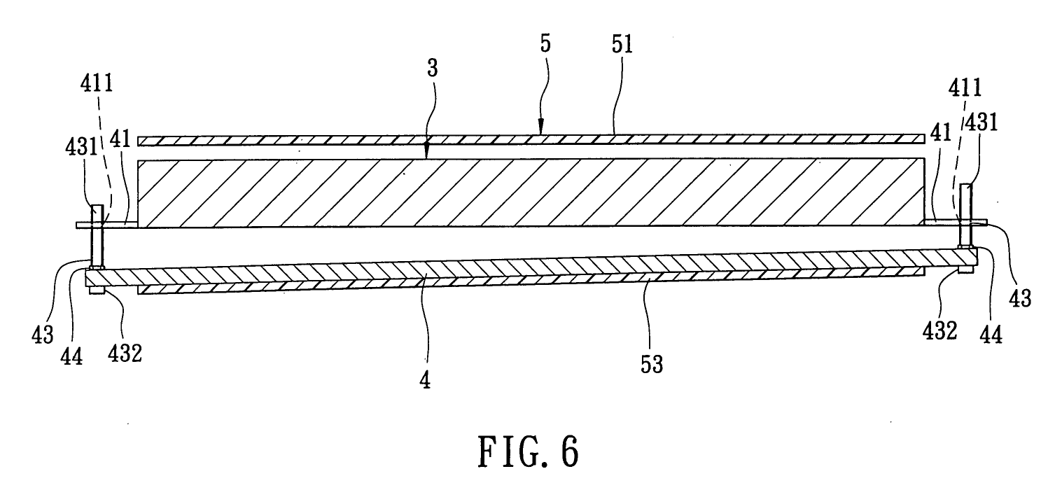

When it is found that the intermediate portion 53 tends to incline rightwardly and downwardly, the pushing rod 4 can be adjusted to a leftwardly and downwardly position shown in FIG. 6 so as to prevent transverse movement of the top belt portion 51 relative to the platform 3.

With this invention thus explained, it is apparent that numerous modifications and variations can be made without departing from the scope and spirit of this invention. It is therefore intended that this invention be limited only as indicated by the appended claims.

I claim:

1. A conveyer belt-adjusting device for a conveyer unit, the conveyer unit including two rollers and an endless conveyer belt that has two opposite sides, a horizontal top belt portion extending between upper ends of the rollers, and a bottom belt portion extending between lower ends of the rollers, said conveyer belt-adjusting device comprising:
a platform having two opposite sides that are adapted to permit the rollers to be disposed respectively and rotatably thereon;
a pushing rod adapted to extend between said platform and the bottom belt portion of the conveyer belt and also between the rollers in a transverse direction of the conveyer belt so as to press against an intermediate portion of the bottom belt portion such that the intermediate portion of the bottom belt portion is disposed below two ends of the bottom belt portion; and
two adjustable supporting units disposed on said platform and adapted to be located respectively at the two opposite sides of the conveyer belt, said supporting units supporting respectively two opposite ends of said pushing rod thereon and operable to move one of said ends of said pushing rods vertically relative to the other one of said ends of said pushing rod.

2. The conveyer belt-adjusting device as claimed in Claim 1, wherein each of said supporting units includes:
a horizontal lug connected fixedly to said platform and having a threaded hole formed therethrough;
a bolt having a threaded portion engaging said threaded hole in said lug, and a head located under said lug; and
a nut engaging said threaded portion of said bolt to clamp a corresponding one of said ends of said pushing rod between said nut and said head of said bolt so that a vertical position of said corresponding one of said ends of said pushing rod is adjustable.
